(19) United States
(12) Patent Application Publication
(10) Pub. No.: US 2012/0158521 A1
(43) Pub. Date: Jun. 21, 2012

(54) System and Method for Personalized Secure Website Portal

(76) Inventor: Nicholas McCullen, Brooklyn, NY (US)

(21) Appl. No.: 13/327,725

(22) Filed: Dec. 15, 2011

Related U.S. Application Data
(60) Provisional application No. 61/465,133, filed on Mar. 15, 2011.
(60) Provisional application No. 61/459,570, filed on Dec. 15, 2010.

(51) Int. Cl. G06F 3/01; G06Q 30/02

(52) U.S. Cl. 705/14.69; 715/760

(57) ABSTRACT

A personal organizer system and method for organizing, linking and presenting social networking, informational, and general websites as well as personal communications systems and media files. A personal organizer system is disclosed comprising a dashboard web page, a settings web page and a news and media web page, each linked by the internet to a host server and database. The personal organizer system securely stores all settings from the settings web page in the database and securely utilizes the stored settings to configure and operate the dashboard web page, including a set of user favorite weblinks, a set of preset weblinks and a set of personalized widgets. A personal organizer device is disclosed for handheld communications devices. The personal organizer device includes dashboard, media player, news and settings functions, and a novel dashboard slider control.

### CROSS-REFERENCE TO RELATED APPLICATIONS

This application claims priority benefit from U.S. Provisional Application No. 61/465,133 filed Mar. 31, 2011 and U.S. Provisional Application No. 61/459,570 filed Dec. 15, 2010.

### BACKGROUND OF THE INVENTION

In modern society, people are connecting to and interacting with other people, sources of information and sources of entertainment at an unprecedented rate through the use of web access devices including computers and handheld communications devices. Furthermore the sheer numbers of connections per person can be astounding. Much time can be wasted simply trying to organize the various connections and the vast amount of information most often contained in disparate places on and off of the internet.

A need exists for a personal organizing system that combines information from disparate sources and organizes it in such a way that allows the user a free flowing experience in search of other people, other information, entertainment and day-to-day functional information such as news and weather.

### SUMMARY

Disclosed is a personal organizer system and method for organizing, linking and presenting social networking, informational, and general websites as well as personal communications systems and media files. The personal organizer system is implemented on a device connected through the internet to a host server. The host server includes a database and a data file storage. The personal organizer system interacts with the host server through a communications manager object that securely authenticates users and utilizes personalized information stored at the host server during operation.

In one aspect of the personal organizer system a dashboard web page is provided including a set of user favorite weblinks, a set of preset weblinks, a set of selectable widgets and a media player. The dashboard web page utilizes data stored in the database and gathered through the communications manager object to display websites in individual “iframes”. The “iframes” function as independent web browser tools.

In another aspect of the personal organizer system, a settings web page is provided to gather and store settings information, including weblinks, background images, user profile data, media player attributes and files, and default settings. The settings are stored in the database and retrieved by the dashboard webpage.

In another aspect of the personal organizer system, a news and media web page is displayed for a preset collection of news and media web links. The news and media web links are preferably made through RSS feeds. The news and media web page will not allow click through of hyperlinks in RSS feeds to change the web page in the browser, instead an “iframe” is opened in the news and media web page encapsulating the hyperlink web page.

In another aspect of the personal organizer system, advertisers are connected to the host server and advertisements are provided to the dashboard web page according to a set of advertisement rules, graphics and media stored in the database and data file storage.

In still another aspect of the invention, a personal organizer device is disclosed as an “app” for handheld communications devices that includes dashboard, media player, news and settings functions with a novel dashboard slider control.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram of a personal organizer system.

FIG. 2 is a block diagram of the database schema of the personal organizer system.

FIG. 3 is a block diagram illustrating the communications manager object of a host server when connected with a user's graphical user interface.

FIG. 4 is a block diagram illustrating the communications manager object of a host server when connected with an advertiser's graphical user interface.

FIG. 5 is a computer screen shot showing the main login web page of the personal organizer application.

FIG. 6 is a computer screen shot showing the sign-up dialogue of the personal organizer application.

FIG. 7 is a computer screen shot showing the dashboard web page of the personal organizer application.

FIG. 8 is a computer screen shot showing an “iframe” opened in the dashboard web page of the personal organizer application.

FIG. 9 is a computer screen shot showing preset website “iframes” in the dashboard web page of the personal organizer application.

FIG. 10 is a computer screen shot showing a set of widgets in the dashboard web page of the personal organizer application.

FIG. 11 is a computer screen shot showing a calendar widget and a calculator widget opened in the dashboard web page of the personal organizer application.

FIG. 12 is a computer screen shot showing a news and media web page of the personal organizer application.

FIG. 13 is a computer screen shot showing a device that manages web links in the settings web page of the personal organizer application.

FIG. 14 is a computer screen shot showing a website editor device in the settings web page of the personal organizer application.

FIG. 15 is a computer screen shot showing a device that manages background images in the settings web page of the personal organizer application.

FIG. 16 is a computer screen shot showing a widget settings device in the settings web page of the personal organizer application.

FIG. 17 is a computer screen shot showing a profile data selector in the settings web page of the personal organizer application.

FIG. 18 is a computer screen shot showing a media manager device in the settings web page of the personal organizer application.

FIG. 19 is a computer screen shot showing a device to change the media player in the settings web page of the personal organizer application.

FIG. 20 is a computer screen shot showing a device to edit media files in the settings web page of the personal organizer application.

FIG. 21 is a computer screen shot showing a device to reset the personal organizer application to default settings in the settings web page of the personal organizer application.

FIG. 22A is a block diagram of a system for implementing a personal organizer device on a handheld communications device.

FIG. 22B is a block diagram of the functions of a personal organizer device.

FIG. 23 is a set of computer screen shots showing the operation of a dashboard slider and the functionality of the dashboard in a personal organizer device.

FIG. 24 is a computer screen shot of personal organizer tool.

FIG. 25 is a computer screen shot of an “iframe” generated from within the news and media web page.

### DETAILED DESCRIPTION

It is to be understood that the personal organizer system and methods described herein may be implemented in various forms of hardware, software, firmware, special purpose processors, or a combination thereof Preferably, the present invention is implemented in software as an application comprising program instructions that are tangibly embodied on a program storage device (e.g., magnetic floppy disk, RAM, CD ROM, ROM and Flash memory), and executable by any device or machine comprising suitable architecture. It is to be further understood that, because some of the constituent system components and method steps depicted in the accompanying Figures are preferably implemented in software, the actual connections between the system components (or the process steps) may differ depending upon the manner in which the present invention is programmed.

Devices of the personal organizer system are implemented within web pages and as webpages which are displayed by a web browser executed by a processor in a client computer system with memory. Pre-defined functions and features are established as programmed instructions included in the web pages. The web browser stores the programmed instructions in the memory and executes them using the client computer and processor, thereby carrying out the pre-defined functions and features. Dynamic functions and features are controlled by a host server which, for example, receives data files such as a media file and a picture file, stores or updates the media file and picture file in an electronic data file storage, and updates a pointer to the media file and a pointer to the picture file in an electronic database server. The host server also receives user profile data from the web pages and updates a user profile in a database based on the user profile data. User profile includes physical attributes of a user including the user's physical home address and physical features. Given the teachings herein, one of ordinary skill in the related art will be able to contemplate these and similar implementations or configurations of the present invention.

Disclosed is a personal organizer including a website portal that organizes and displays a set of favorite websites, pictures, video files, audio files, news and widgets stored at a secured location and accessed via the internet. A user is provided the ability to customize links to third-party websites. The customized links and widgets appear as selectable “buttons” used to access the third-party websites. Audio and video files are accessed by a streaming media player displayed as a popular portable media device.

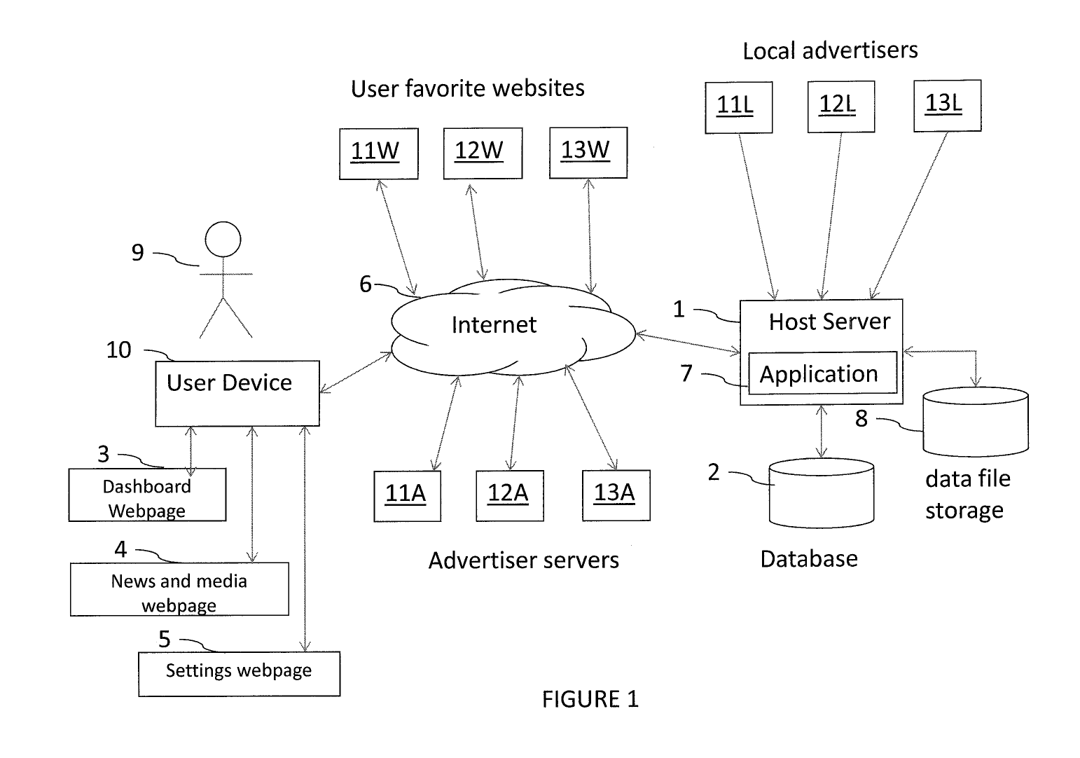

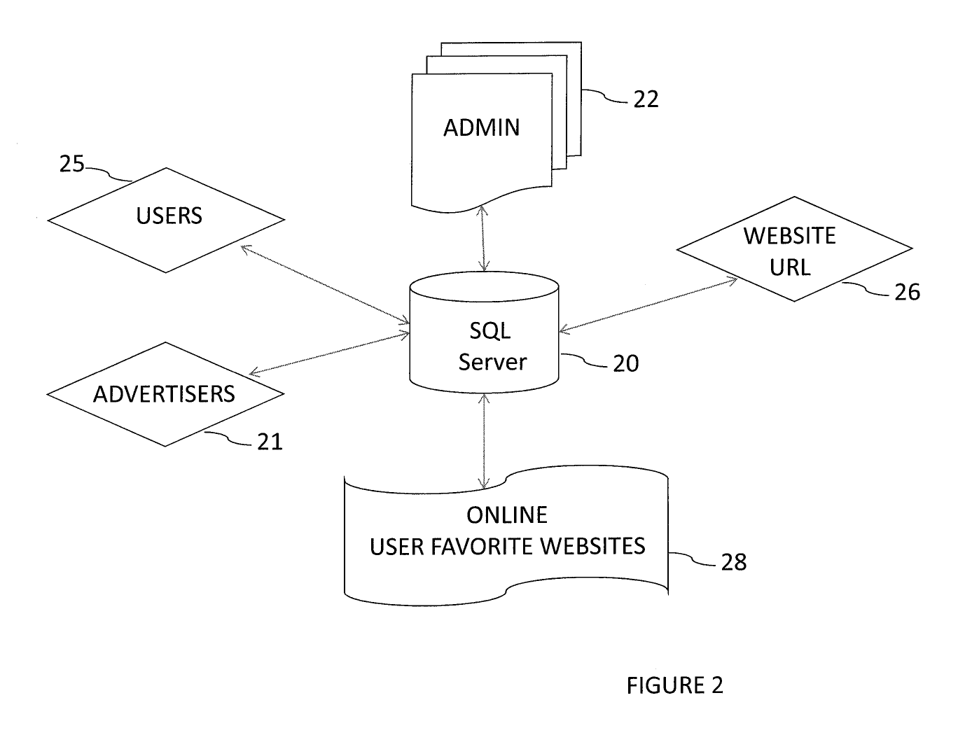

Referring to FIGS. 1 and 2, the personal organizer system includes a host server 1 comprising a personal organizer application 7 supporting a web portal service, a database 2 and data file storage 8. Host server 1 is connected to the internet 6 and further connected to user device 10 and to a set of user favorite websites 11W, 12W and 13W through internet 6.

Host server 1 is also connected to a set of advertisers 11A, 12A and 13A through internet 6. Alternatively or in simultaneity, host server 1 stores and accesses data in data file storage 8 for a set of local advertisers 11L, 12L and 13L wherein host server 1 acts as an advertisement server for one or more local advertisers. In yet another embodiment, host server 1 stores and accesses data for the set of local advertisers 11L, 12L and 13L through a dedicated advertiser server connected to host server 1 by a local area network.

User device 10 is associated to and operated by a user 9. User device 10 includes a native web browser graphical user interface (GUI) that when connected with and under the direction of personal organizer application 7, displays a dashboard webpage 3 for selecting from the set of user favorite websites 11W, 12W and 13W on a display attached to the user device, a news and media web page 4 and a settings web page 5. The web browser GUI also interacts with the user to exchange web site data streams and operational instructions with the host server 1, the operational instructions encompassing all the normal means of communication between the user and the user device such as mouse clicks by the user on particular screen areas, typing information on a keyboard, speech interpretation if enabled, etc. The web browser GUI, with the direction of personal organizer application 7, also displays and processes interactions with advertisement graphics and media for the set of advertisers 11A, 12A and 13A and the set of local advertisers 11L, 12L and 13L. The web site data and the operational instructions are usually in the form of HTML formatted data, but may also include programmed code, such as Java scripts, executed locally by the web browser GUI.

Database 2 stores user attributes and settings, user favorite website data including icon images and URLs for the set of user favorite websites 11W, 12W and 13W and administration data such as advertiser profiles for the set of advertisers 11A, 12A and 13A and the set of local advertisers 11L, 12L and 13L. Database 2 includes file location pointers to additional data stored in data file storage 8, for example, pictures and audio files. Database 2 is maintained and accessed in SQL format and is modifiable by the user with respect to user profile data, user settings and user favorite website data. Standard database maintenance protocols are available to managers of the host device to modify all data in the database. The personal organizer application also supports the capability of communicating with the advertisers to post advertisements in exchange for a fee and further performs accounting functions with respect to collecting advertiser fees.

Referring to FIG. 2, database 2 includes a database server 20 and a set of tables, containing various sets of data, stored in memory and in persistent storage devices. The set of tables comprise an administrative table 22 holding administrative information for the database including login authentication data, a users table 25 holding user data, an advertisers table 21 holding advertisement data, a website URLs table 26 holding web addresses and an online user favorite websites table 28 holding web addresses of user selected favorite websites. Each table contains a set of records, each record includes a set of data fields. Example database servers are SQL Server and MSSQL from Microsoft Corporation and MySQL from Oracle Corporation.

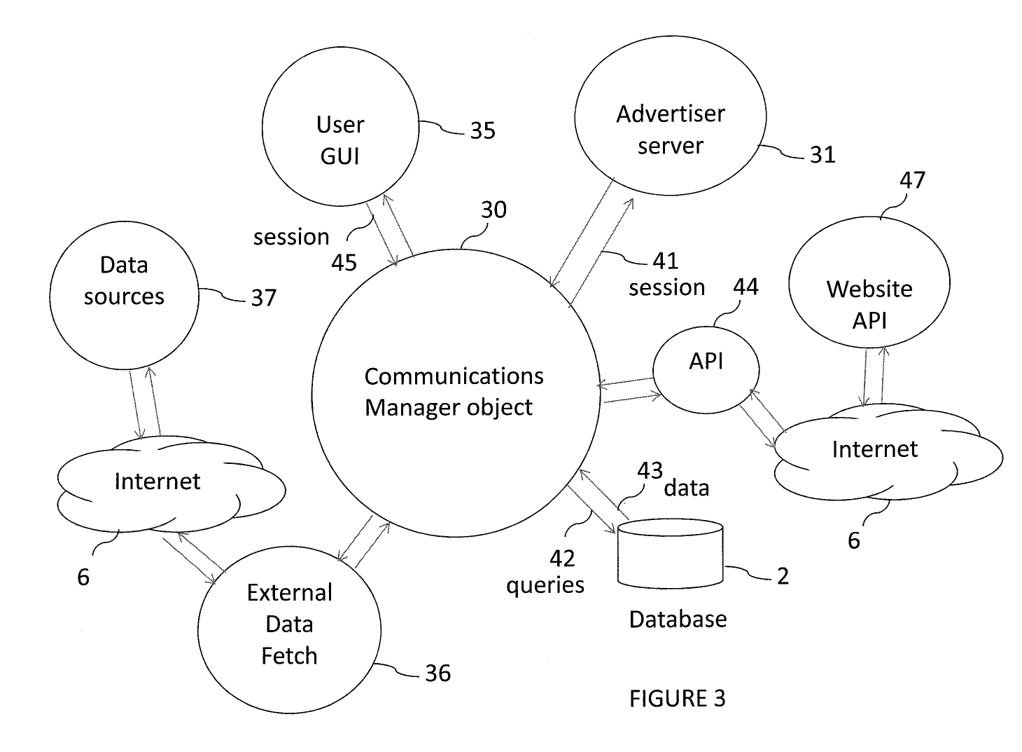

Referring to FIG. 3, the personal organizer application includes a communications manager object 30 operating on the host server 1 and associated to a user. Communications manager object 30 includes a web server which is in communication with a user graphical user interface (user GUI) 35 through secure session 45. Communications manager object 30 sends information and receives advertisement data from an advertiser server 31 through secure session 41. The communications manager object 30 exchanges data, such as weather information and streaming media, with an external data fetch connected to a set of external data sources 37 through the internet 6. The communications manager object 30 also sends queries 42 to database 2 and receives data 43 from database 2 including user attributes such as a user profile, social networking data (friends and pictures), clock attributes, media player attributes, media streams and logon authentication data to and from the database. Data 43 also includes locally stored advertiser data such as advertisement schedules, graphics and audio.

The personal organizer application also includes a special API 44 configured to interact with a website API 47 to exchange log in information, such as username and password and to communicate other preferred website configuration data.

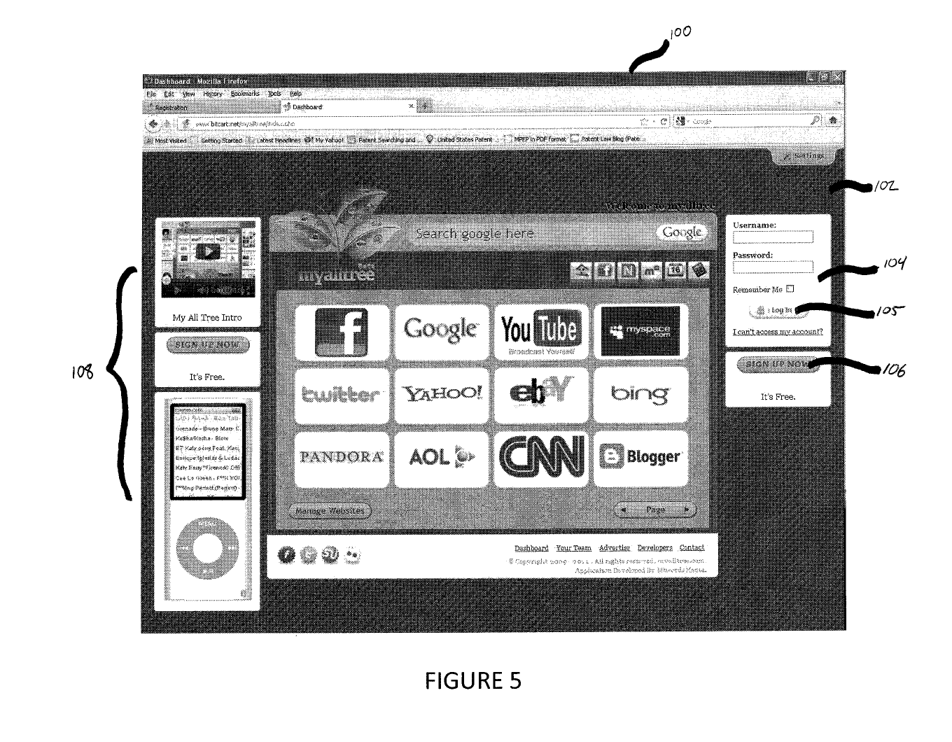

The user GUI 35 comprises a web browser securely communicating with communications manager object 30 and displaying a set of web pages generated by the host server. At least one web page displays customized links to the set of user favorite websites. The set of web pages also display advertisements from the advertising server and the locally stored advertiser data. The set of web pages display customizable widgets, for example, social networking connections, a personalized clock, a media player, and a weather updater. Examples of the web pages are shown in FIGS. 5-21 and explained further below.

In use, a user operating the user GUI, browses to a main login web page hosted by the host server and logs into the personal organizer application, invoking a secure communication session between the user device and the host server. The user is authenticated by the host server, a communication manager object is instantiated for the user and the user's profile is loaded into the communication manager object. A dashboard web page is generated and displayed by the communication manager object. The dashboard web page displays a set of customized links to a set of user favorite destination websites associated to the user and is configured to allow the user to access user settings data in the database. The dashboard web page provided by the secure communication session also displays advertisements by a set of advertisers.

When the user selects one of the user favorite destination sites, the content of an associated URL is communicated and loaded into the user GUI through the secure communication session from the host device. The user GUI is then connected directly through the internet to the user favorite destination site. If the selected user favorite destination site requires authentication or other configuration, then special API 44 is enabled for the corresponding website API 47. The communications manager object then sets up the website by performing all authentication and configuration prior to loading the user GUI with the associated URL. Once the authentication is accomplished, the user GUI is loaded with the associated URL and connected to the user favorite destination site.

When the user terminates the communication session without closing the web browser, the host server returns to displaying the main login web page.

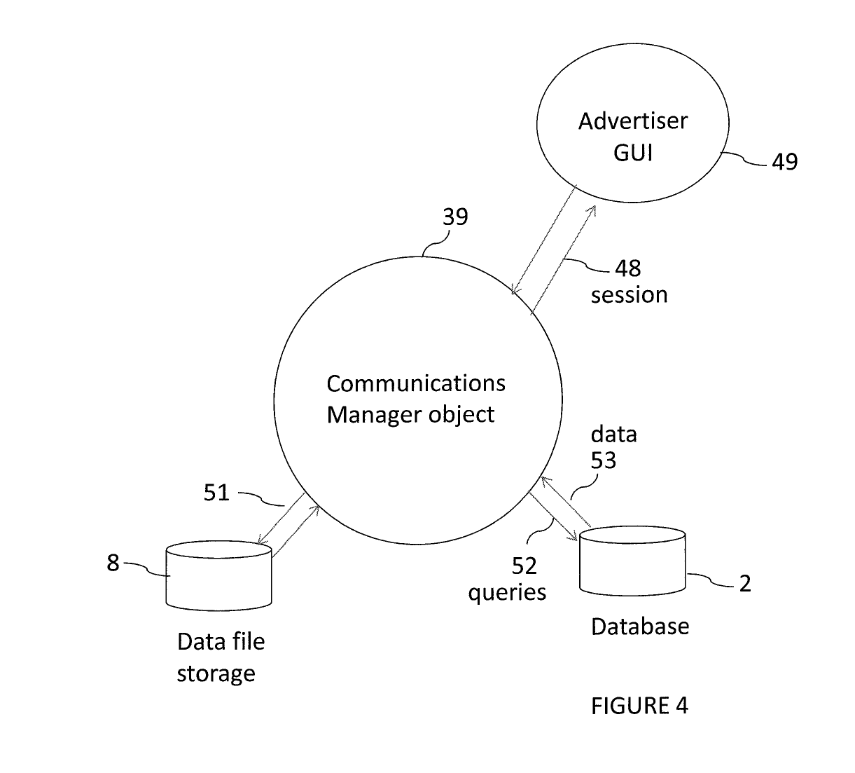

Referring to FIG. 4, the personal organizer application includes a communications manager object 39 operating on the host server 1 and associated to a web advertiser. Communications manager object 39 includes a web server which is in communication with an advertiser graphical user interface (advertiser GUI) 49 through secure session 48. Communications manager object 39 generates and sends web pages to advertisement GUI 49 related to configuring advertisements and receiving advertisement reporting data. Communications manager object 39 also sends queries 52 to database 2 and receives data 53 from database 2 including advertiser attributes such as an advertiser profile, advertisement graphics and audio file pointers, pricing, accounting, advertisement reporting data and advertisement scheduling rules. Communications manager 39 includes a download function so that advertisement graphics and audio files are sent from advertisement GUI 49 through communications manager object 39 to data file storage 8.

In use, an advertiser operating the advertiser GUI, logs on to a main advertiser login web page served by the host server. After authenticating, a secure communication session is established between advertiser GUI 49 and communications manager object 39 wherein the advertiser downloads new advertisements, downloads new advertisement schedules and rules, and collects advertising reporting data through web pages served by the communications manager object 39.

The functions and features of the personal organizer system are now described in relation to the web pages generated and controlled by the host server. The functions and features are displayed and played by a web browser executed on a client computer. FIGS. 5-24 are screen shot images of a preferred embodiment of the set of web pages created and serviced by the personal organizer application.

Beginning with FIG. 5, main log-in web page 102 is rendered in a web browser 100. Log-in web page 102 comprises a login dialogue 104, a sign-up selector 106 and a display of personal organizer system features 108 available to a registered user, but rendered inoperable on the log-in web page.

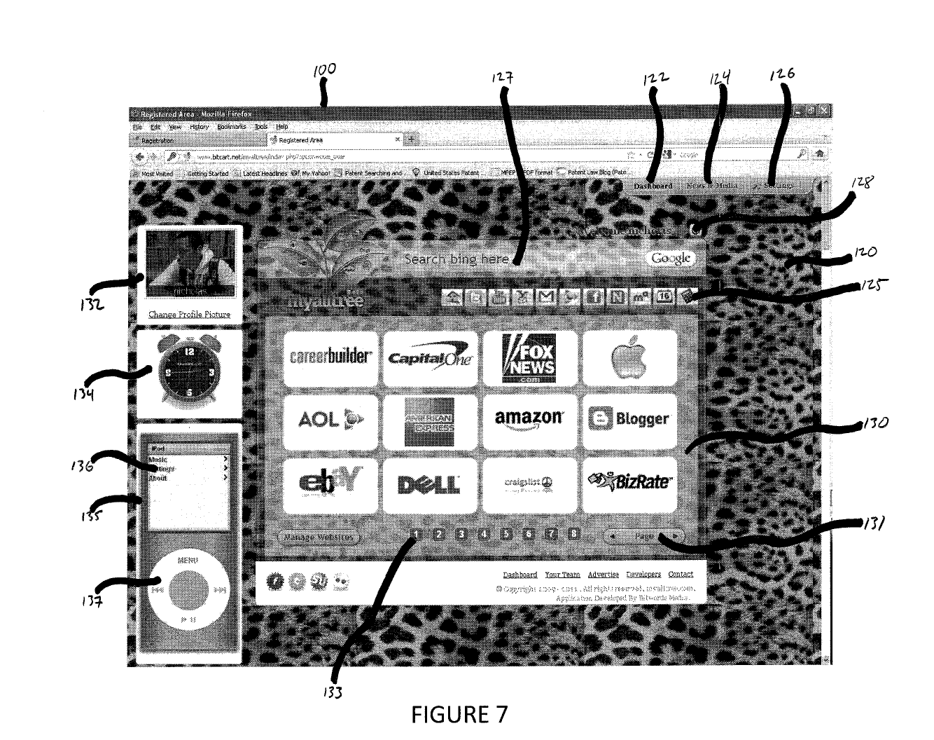

In use, when log-in dialogue 104 is filled in with log-in information including a username and password, then submitted by clicking log-in button 105, the web browser sends the log-in information to the host server where it is authenticated. If authenticated, a dashboard web page associated to the username is rendered by the web browser as in FIG. 7 and web browser 100 is connected to a connection manager object of the host server. If not authenticated, an appropriate message is displayed in the log-in web page.

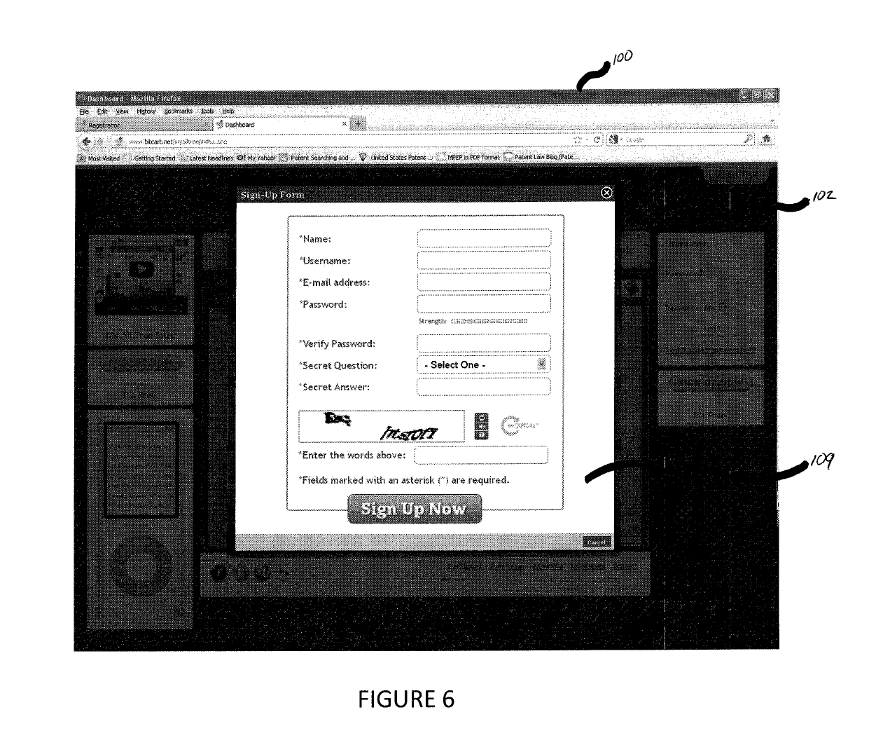

According to FIG. 6, when sign-up selector 106 is selected in log-in web page 102, a sign-up dialog 109 is rendered by web browser 100.

In FIG. 7, dashboard web page 120 is displayed in web browser 100. Dashboard web page 120 comprises a set of selectable website links 130 displayed centrally as a set of boxed images and scrollable by a scroll device 131, a set of preset website selectors 133 displayed as numbered boxes, a set of widgets 125 displayed as icons and a search dialogue 127 displayed above the set of widgets and the set of selectable website links. Dashboard web page 120 further comprises a picture frame 132 displaying a user selected picture, a date and time frame 134 displaying a clock function, a media player 135 displaying a media menu 136 and having a set of media controls 137.

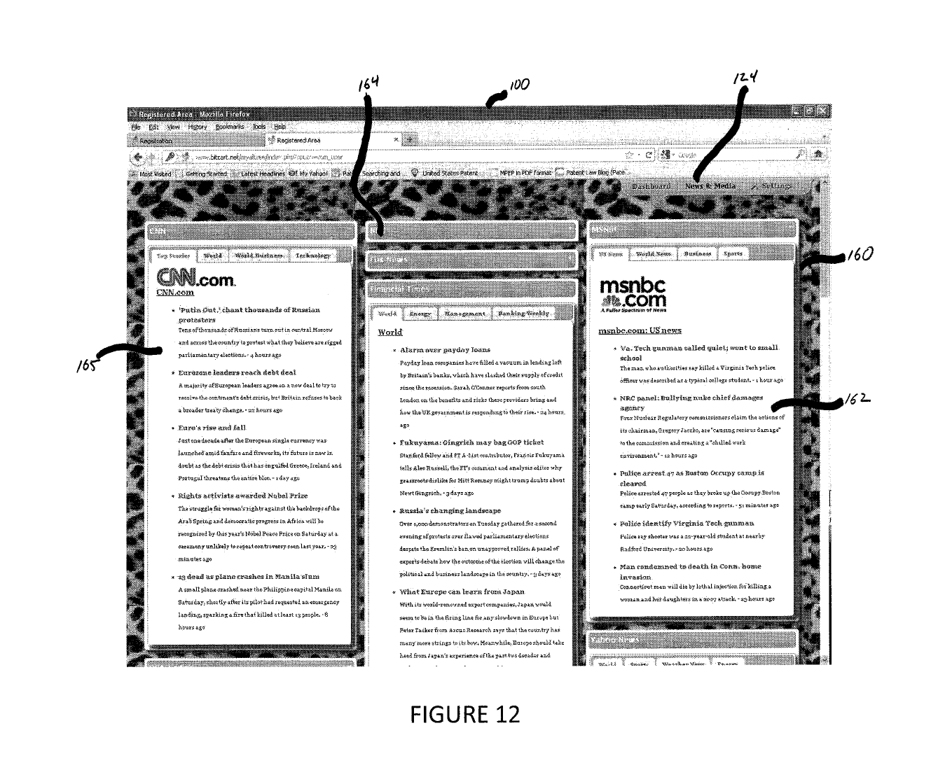

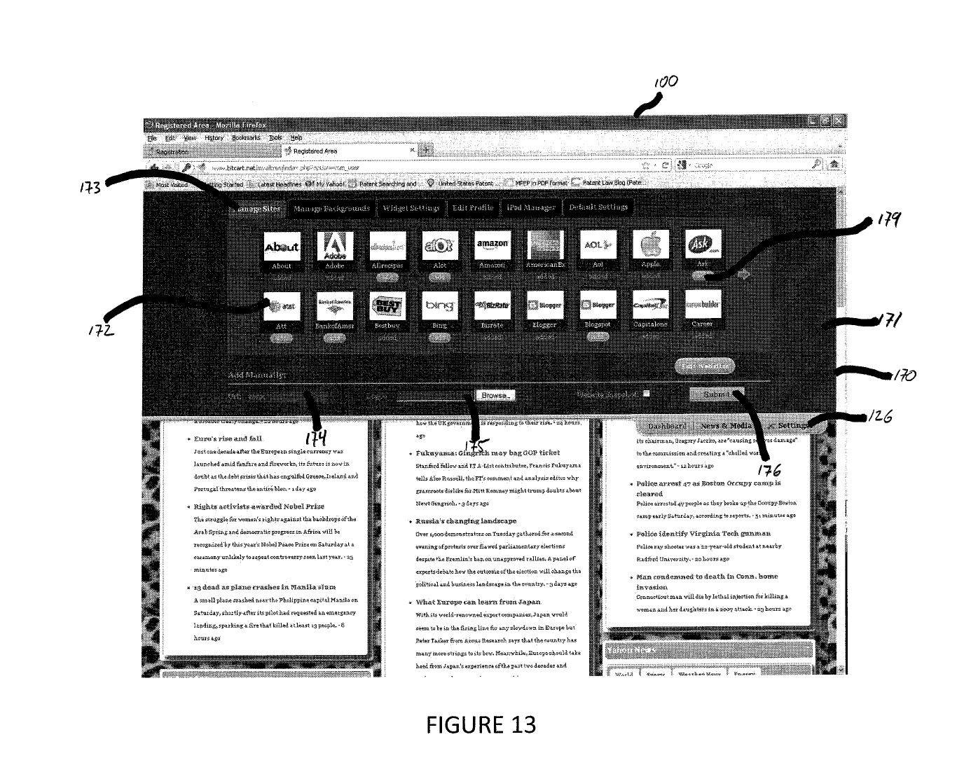

Dashboard web page also comprises a settings tab 126, a news tab 124, a dashboard tab 122 and log-off button 128. In use, selecting the settings tab 126 causes web browser 100 to display a settings web page as shown in FIGS. 13-21. Selecting the news tab 124 causes the web browser 100 to display a news web page as shown in FIG. 12. Selecting the dashboard tab 122 causes web browser 100 to display the dashboard web page. Selecting the log-off button 128 causes web browser 100 to display the main log-in web page as shown in FIG. 5 and to disconnect web browser 100 from a connection manager object.

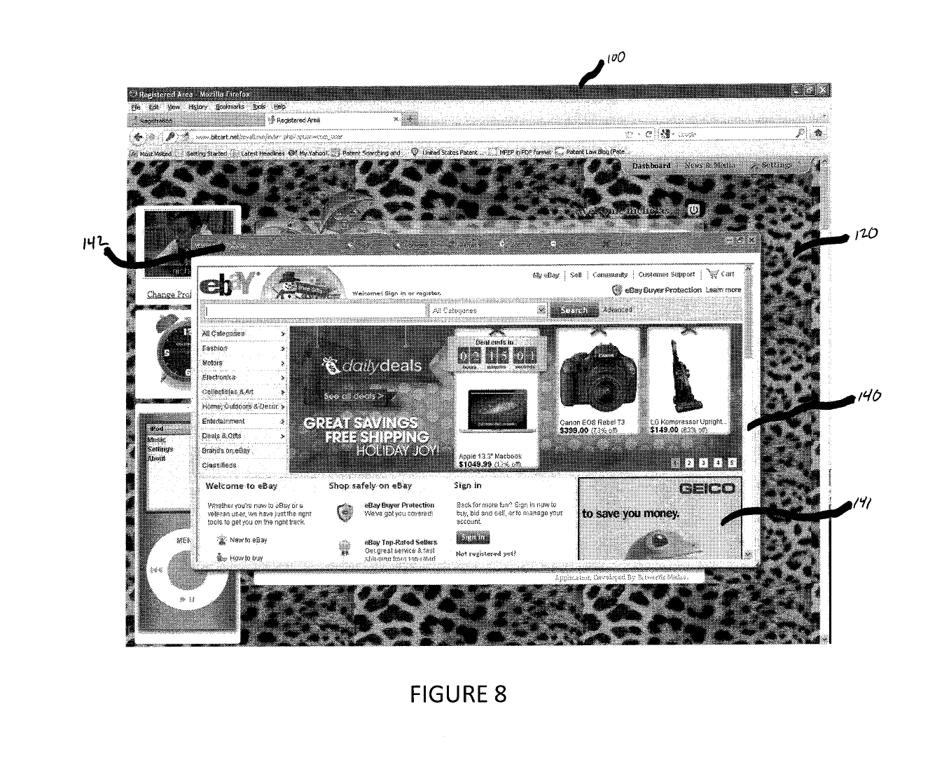

Refer to FIGS. 7 and 8. In use, when a boxed image associated to a selectable website link is selected in dashboard web page 120, an “iframe” 140 is displayed by the web browser. “iframe” 140 displays the contents of the web page 141 associated to the selectable website link. Web page 141 is fully operable including any functions defined by the associated web site and associated web server. “iframe” 140 also includes its own set of browser controls 142 comprising a back control, forward control, refresh control, zoom controls and close control as well as sizing and reducing controls for the “iframe” window. As a user migrates deeper into a website within an “iframe”, the current URL is saved in the database at the host server and is associated to the selectable website link. If the user closes the “iframe” and then, at a later time, reopens a new “iframe for the selectable website link, the connection manager object opens the saved current URL the new “iframe”, if authentication is not required.

In the example of FIG. 8, “eBay” boxed image was selected and the “eBay” main web page is displayed in the “iframe”. If a user had previously registered with the “eBay” website having an “eBay” username and password, the “eBay” username and password is also automatically stored in the database of the host server for the personal organizer system. When the user selects the “eBay” boxed image, the dashboard web page directs the request to the communication manager object for the session which gets the “eBay” username and password from the database, opens a special API (if it exists) and exchanges a handshake protocol with an “eBay” web service API (if it exists) to authenticate the username and password. The communication manager object then instructs the “eBay” web page to open in an “iframe” with the “eBay” username and password. This API based authentication process is made available to and repeated for all linked websites in the dashboard web page, whether accessed by the set of preset website links, the set of widgets or the set of selectable website links.

Further to FIG. 7, the dashboard web page in use, receives and displays, in picture frame 132, an image of a preselected picture stored in the database. The dashboard web page receives and displays the time and date from a date and time server on the internet. The dashboard web page displays media player 135 and based on one or more media selections in media menu 136 and in coordination with media controls 137, plays the one or more media selections using client computer display and audio devices.

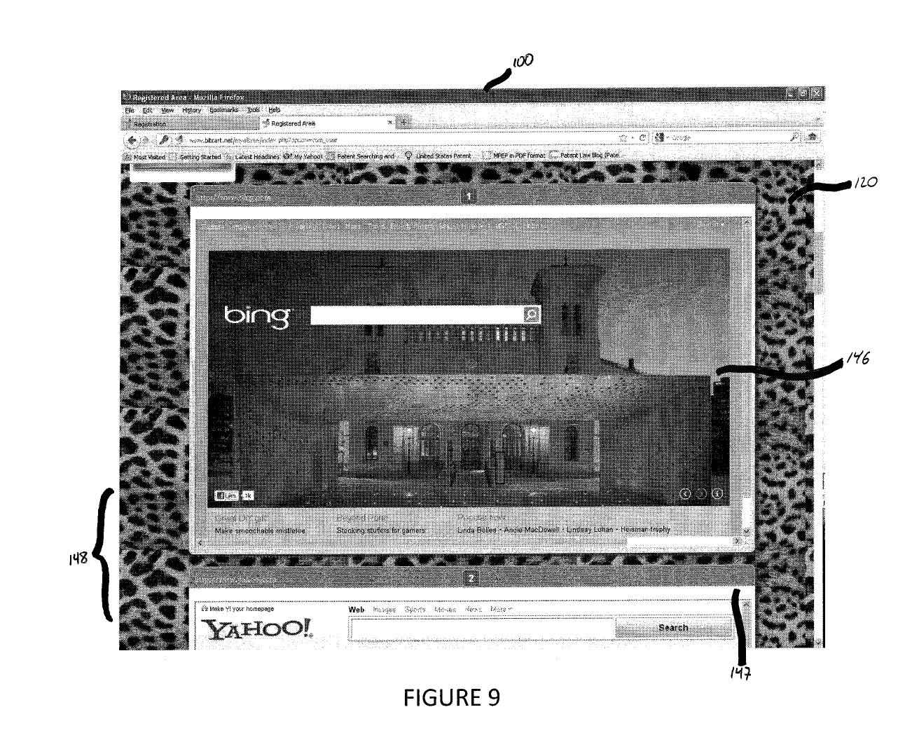

According to FIGS. 7 and 9, dashboard web page 120 in use, automatically displays a set of preset websites in a set of “iframes” 148 with preset web URLs as assigned by the set of preset website selectors 133 and stored in the database. FIG. 9 shows that the set of “iframes” 148 are preferably displayed by web browser 100 in order from top to bottom by scrolling web browser 100 downward. Here “iframe” 146 associated to preset website selector “1” is displayed above “iframe” 147 associated to preset website selector “2” and so forth. When a preset website selector is selected in the dashboard webpage, a preset website dialogue is displayed which captures, associates and stores a web URL in the database.

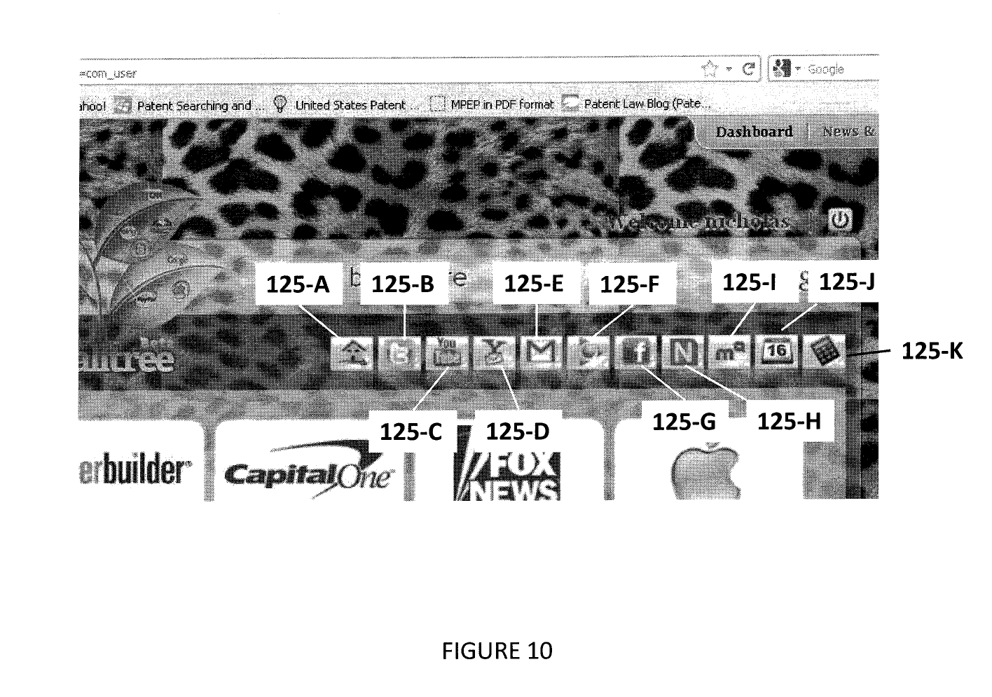

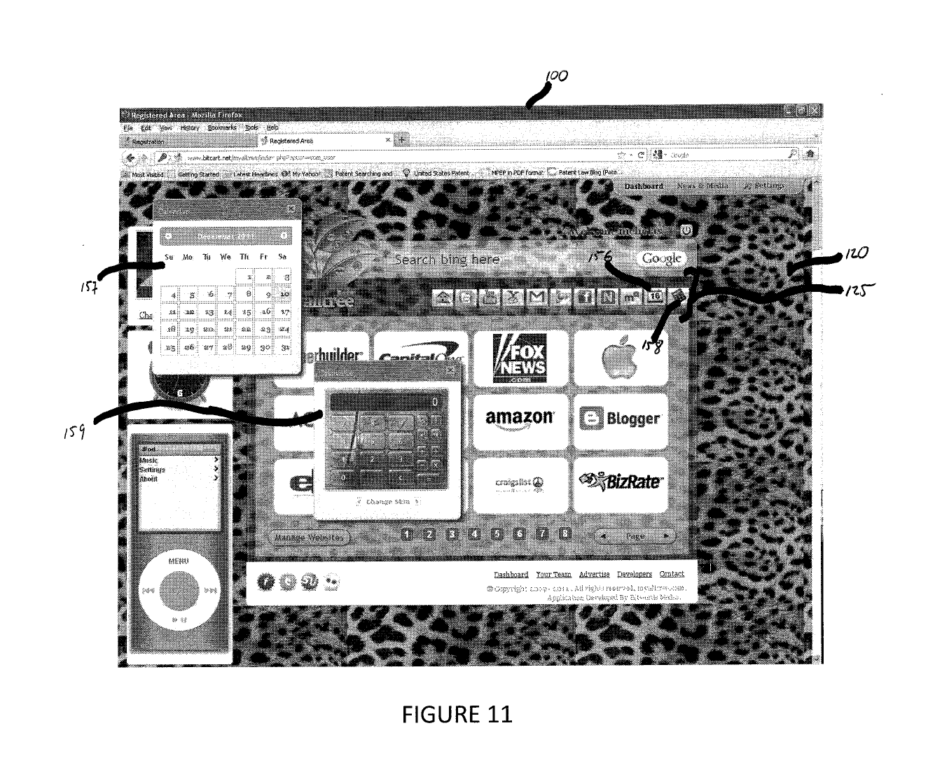

Referring to FIGS. 10 and 11, dashboard web page 120 in use will respond to the selection of one or more of the set of widgets 125. The response of dashboard web page 120 is indicated in FIG. 11 which shows a set of exemplary functions for the set of widgets 125. Widgets 125-A through 125-K are exemplary only and should not be construed as limiting the invention. Many other widgets are conceived that could be integrated into the set of widgets and into the operation of the dashboard web page.

Widget 125-A when selected, causes web browser 100 to store the dashboard web page as its home page. Widget 125-B when selected, logs a user into a twitter account and displays the associated twitter web page in an “iframe”. Widget 125-C when selected, logs a user into a YouTube account and displays the associated YouTube web page in an “iframe” which further allows YouTube videos to be viewed. Widget 125-D when selected, logs a user into a yahoo mail account and displays the associated Yahoo mail web page in an “iframe”. Widget 125-E when selected, logs a user into a gmail account and displays the associated gmail web page in an “iframe”. Widget 125-F when selected, logs a user into an AOL account and displays the associated AOL web page in an “iframe”. Widget 125-G when selected, logs a user into a Facebook account and displays the associated Facebook web page in an “iframe”. Widget 125-H when selected, logs a user into a Ninite account and displays the associated Ninite web page in an “iframe”. Widget 125-I when selected, logs a user into a mapquest account and displays the associated mapquest web page in an “iframe” or if there is no account, displays the mapquest map on a web page where the map is most closely associated to the user's location in the user's profile. Widget 125-J when selected, displays and operates a calendar device in the dashboard web page. Widget 125-K when selected, displays and operates a calculator device in the dashboard web page. FIG. 11 is a screen shot of the dashboard web page showing a calendar device 157 resulting from selecting widget 125-J and a calculator device 159 resulting from selecting widget 125-K.

Most of the widgets are associated to a pre-selected web service. If a special API exists for the pre-selected web service, then the special API is opened by the communication manager object and interacts with the pre-selected web service to authenticate usernames and passwords as stored in the database for the user and the widget, and further passes any additional information from the database required by the pre-selected web service. Once authenticated through the special API, the communications manager object opens an “iframe” for the pre-selected web service.

Referring to FIGS. 7 and 12, anytime that news tab 124 is selected, news and media web page 160 is displayed by web browser 100 as shown in FIG. 12. News and media web page 160 comprises a set of news window devices 162 which are preferably connected to internet news sources by RSS feed.

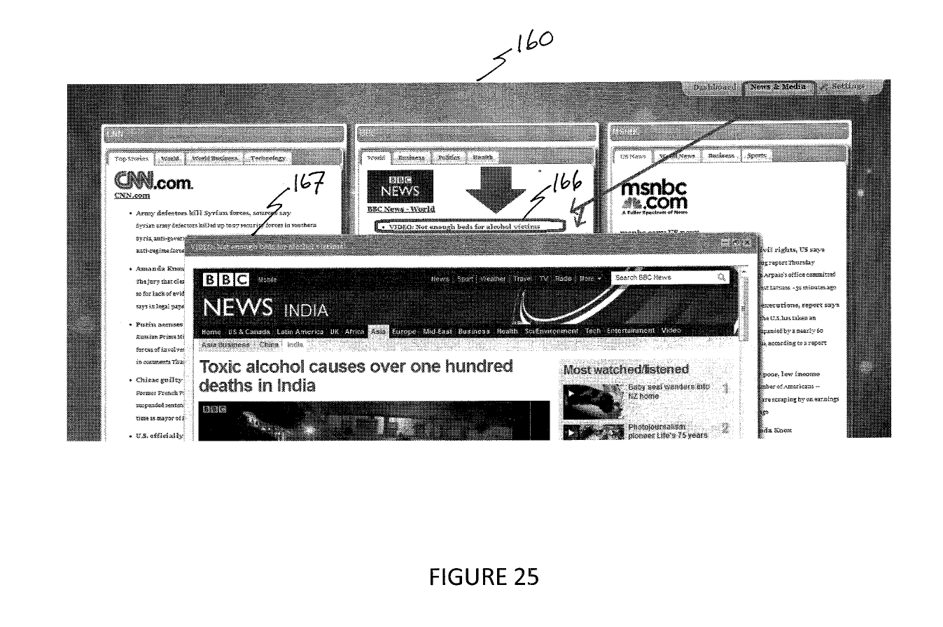

In use, set of news window devices 162 display selectably as open news windows 165 and closed news windows 164 and can be moved, opened, closed and positionally organized on news and media web page 160 as desired. As shown in FIG. 25, news and media web page 160 will not allow click through of a hyperlink 166, embedded in the RSS feeds in order to change the web page in the browser. Instead an “iframe” 167 is opened in news and media web page 160 encapsulating the hyperlink web page. This novel feature guarantees that the user will continue to see any advertisements on the news and media page.

Referring to FIGS. 7 and 13, anytime that settings tab 126 is selected, settings web page 170 is displayed by web browser 100 as shown in FIG. 13. A device of settings web page 170 is selectable by selecting one of a set of settings tabs 173 appearing near the top of the settings web page. In the preferred embodiment, the set of settings tabs 173 include a “manage sites” tab, a “manage backgrounds” tab, a “widget settings” tab, an “edit profile” tab, an “ipod manager” tab (media manager tab) and a “default settings” tab.

FIG. 13 shows the “manage sites” device 171 of the settings web page 170 displayed by default on opening the settings web page and displayed after selection of the “manager sites” tab. “Manage sites” device 171 comprises a set of available website links and images 172, a URL add dialogue 174, a image add dialogue 175, a submit selector 176 and a website organizer selector 178. Settings web page 170 also displays a status selector 179 below each website link in the set of available website links and images.

In use, when the status selector of an available website link is selected so that the status reads “added”, “manage sites” device 171 causes the available website link to appear along with its image in the set of selectable website links of the dashboard web page. Furthermore, when URL add dialogue 174 is filled out with a valid web URL, a website image is selected in the image add dialogue 175 and submit selector 176 is selected, the valid web URL and website image is displayed as an available website link in set of website links and images 172.

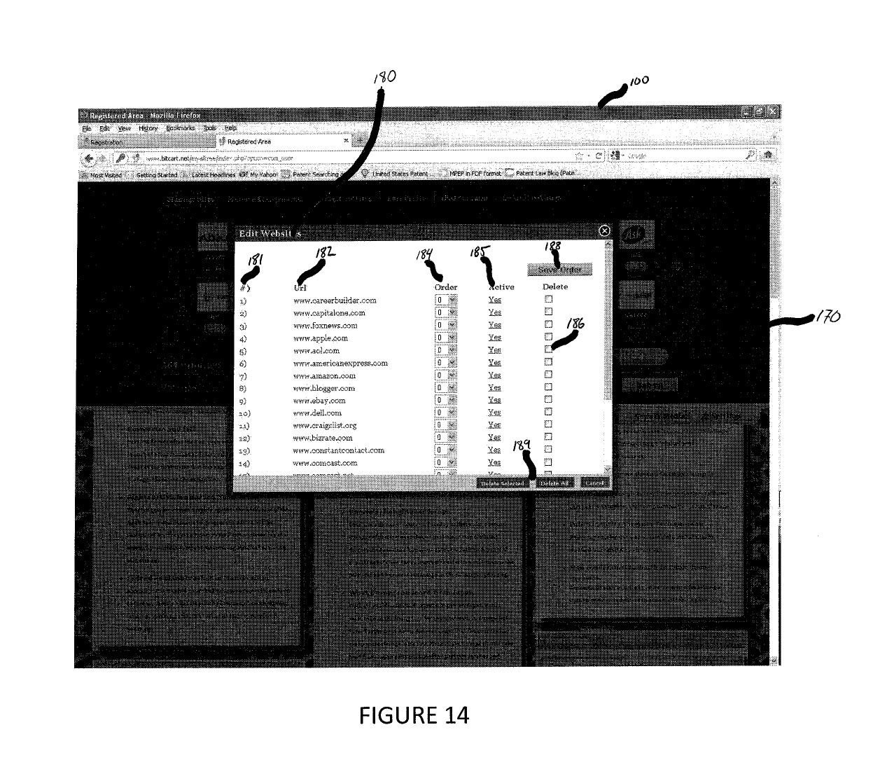

Upon selection of the website organizer selector 178, a website editor device 180 is displayed by settings web page 170 in web browser 100 according to FIG. 14. Website editor device 180 comprises the list of available website links arranged by current order number 181 and further including the website link's URL 182, new order number 184, active status 185 and delete selector 186. Website editor device 180 also includes a save selector 188 and a set of exit functions 189 including functions to delete selected items, delete all items and cancel (close) the website editor device without further changes.

In use, website editor device sets the order in which website links are displayed in the set of selectable website links of the dashboard web page. The order is changed by entering a new order number for a given website link and selecting the save selector 188. A website link is made active or inactive by selecting the area near the active status 185 of the website link. A website link is deleted from the list of available website links by selecting the corresponding delete selector 186 of the website link and selecting “delete selected” from the exit functions 189. All information selected in the “manage sites” device 171 is uploaded to the database and associated to the logged-in username.

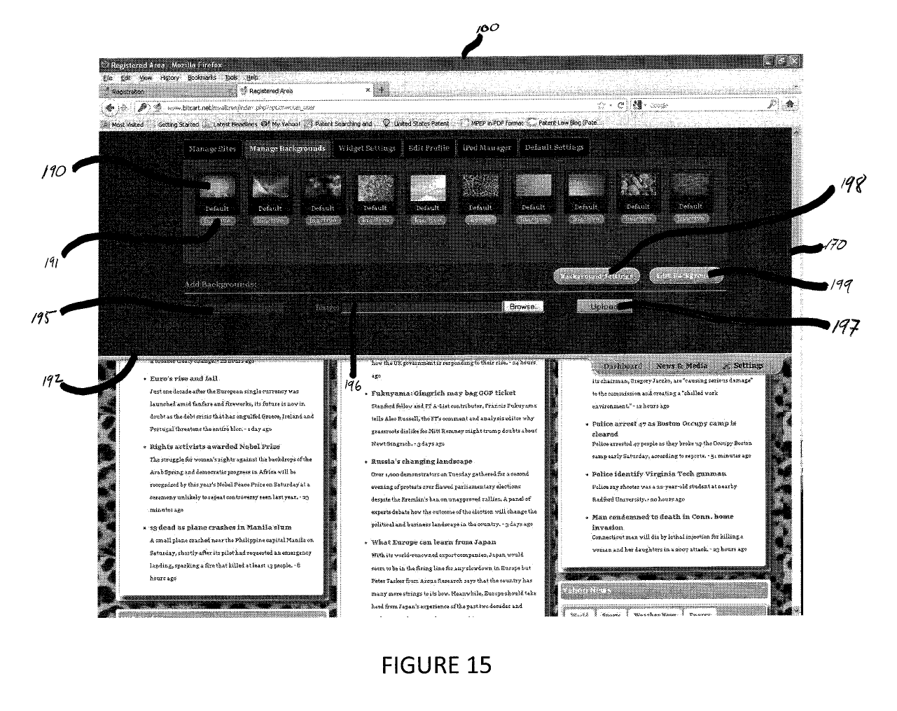

FIG. 15 shows the “manage backgrounds” device 192 of settings web page 170 displayed by web browser 100 after selection of the “manager backgrounds” tab. “Manage backgrounds” device 192 comprises a set of background images 190 associated with a set of background image selectors 191, an add title dialogue 195, an add background image dialogue 196, an upload device 197, a background settings selector 198 and an edit backgrounds selector 199.

In use, when a background image selector in the set of background image selectors is selected to be active, the associated background image becomes the background for the dashboard web page and the news and media web page. When upload device 197 is invoked with valid information in add title dialogue 195 and add background image dialogue 196, a new background image and associated selector is included in the set of background images. When background settings selector 198 is selected, a dialogue appears to allow for tiled or centered format for background image display. When edit backgrounds selector 199 is selected, an image editor is invoked to allow a user to change the background image. All information selected in the “manage backgrounds” device 192 is uploaded to the database and associated to the logged-in username.

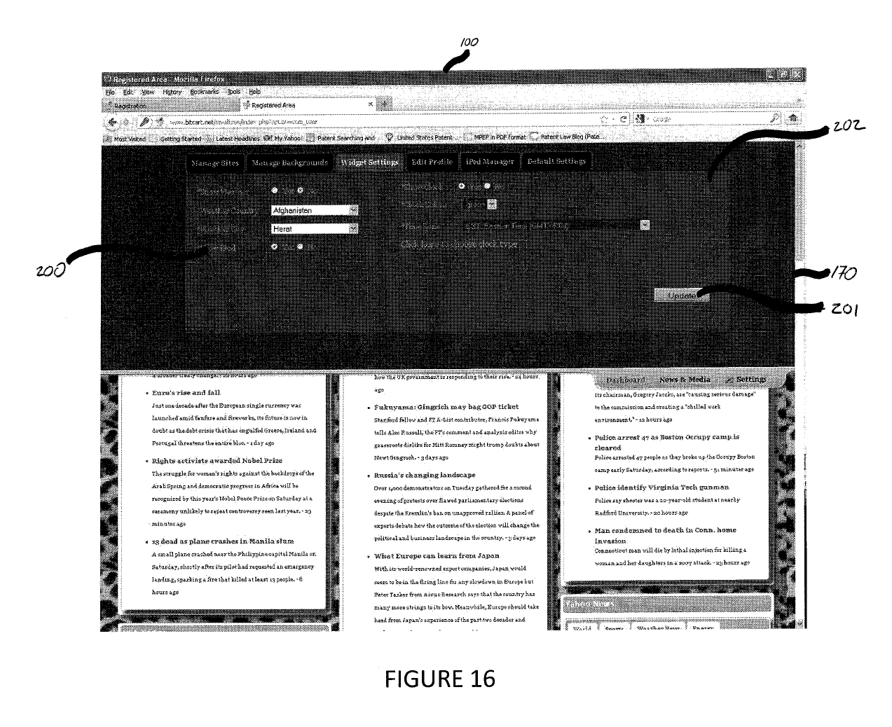

FIG. 16 shows the “widget settings” device 202 of settings web page 170 displayed by web browser 100 after selection of the “widget settings” tab. “Widget settings” device 202 comprises a set of selectable widget functions 200 and an update device 201.

In use, widget functionality for the set of widgets available in the dashboard web page are chosen through interaction with the “widget settings” device 202, specifically by setting functionality in the set of selectable widget functions 200. For example, a weather display widget will obtain and display weather for a location selected from “weather country” and “weather city”. In another example, the media player will be displayed and operated by the dashboard web page if “Show ipod” is selected as “Yes”. All information selected in the “widget settings” device 202 is uploaded to the database and associated to the logged-in username.

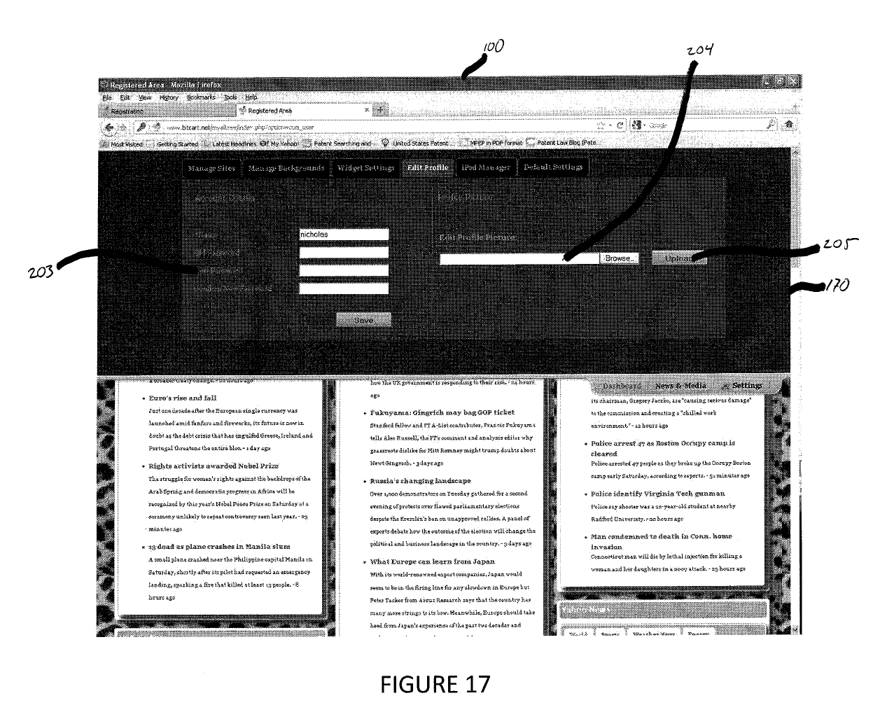

FIG. 17 shows a profile data selector 203 of settings web page 170 displayed by web browser 100 after selection of the “edit profile” tab. Profile data selector 203 comprises a dialogue for setting a username and password, a profile picture selector 204 and an upload device 205 for uploading a profile picture. In use, the username and password submitted in the profile data selector is stored in the database by the host server. A profile picture is uploaded to the data file storage on the host server by using upload device 205 and browsing locally stored image files using profile picture selector 204.

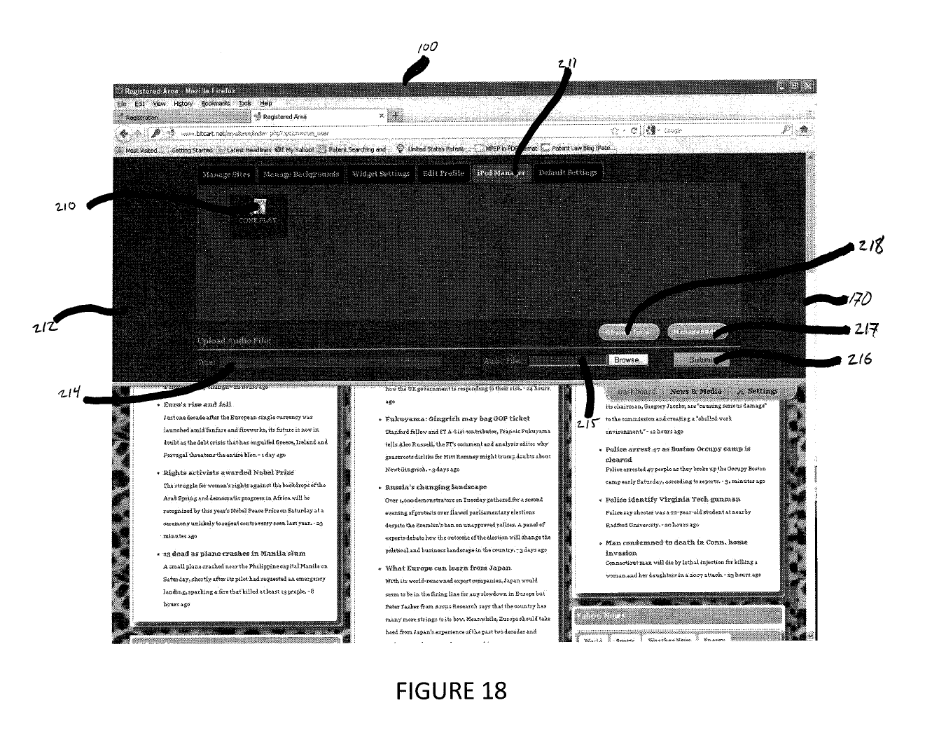

FIGS. 18, 19 and 20 show a “media manager” device 211 of settings web page 170 displayed by web browser 100 after selection of the media manager tab. “Media manager” device 211 comprises a set of media files 210, a dialogue device 212 for uploading media, a media player selector 218 and a “manage media” selector 217. The dialogue device 212 further comprises a media title text selector 214, and a local media file selector 215 for selecting locally stored media files for uploading and a submit device 216 to start an uploading process.

In use, media files are uploaded to the data file storage on the host server by using local media file selector 215 and media title selector 214 to select and name a new media file for upload. Upon selecting the submit device 216, the new media file is uploaded to the data file storage and, in the database, added to a list of media files corresponding to set of media files 210. The settings webpage 170 then updates set of media files 210 in web browser 100.

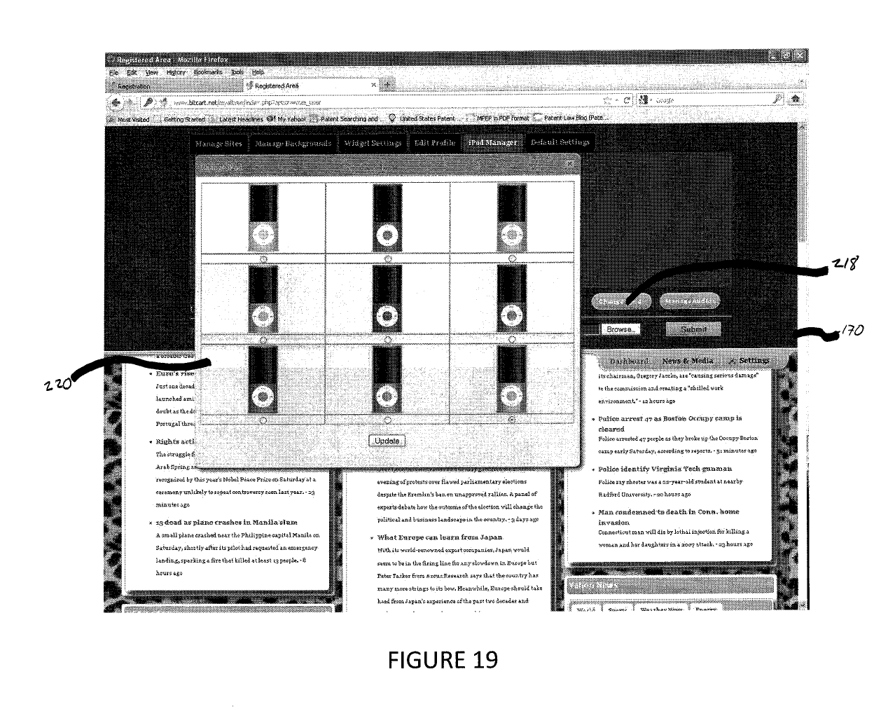

On selection of media player selector 218 a change player device 220 is displayed by settings web page 170 in the web browser as shown in FIG. 19.

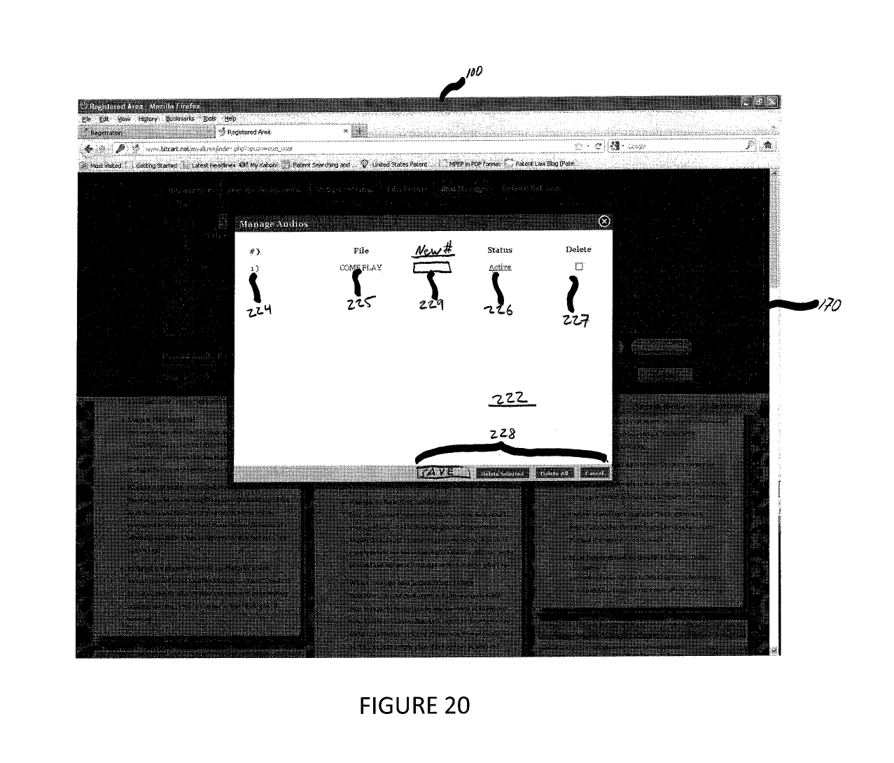

On selection of “manage media” selector 217, media organizer device 222 is displayed by settings web page 170 in web browser 100 as shown in FIG. 20. Media organizer device 222 organizes the list of media files including for each media file: a current order number 224, a media title 225, a new order number 229, a media file status 226 as “active” or “inactive” and a delete selector 227. Media organizer device 222 also includes a set of exit functions 228 including a save function, a delete selected items function, a delete all items function and a cancel (close) function that closes the media organizer device.

In use, media organizer device 222 sets the order in which media titles are displayed in the media player of the dashboard web page. The order is changed by entering a new order number for a given media title and selecting “save” in the set of exit functions. A media file is made active or inactive by selecting the area near the active status 226 of the media title. A media file is deleted from the list of available media files by selecting one of the delete functions in the set of exit functions. All information selected in the “media manager” device 211 is uploaded to the database and associated to the logged-in username.

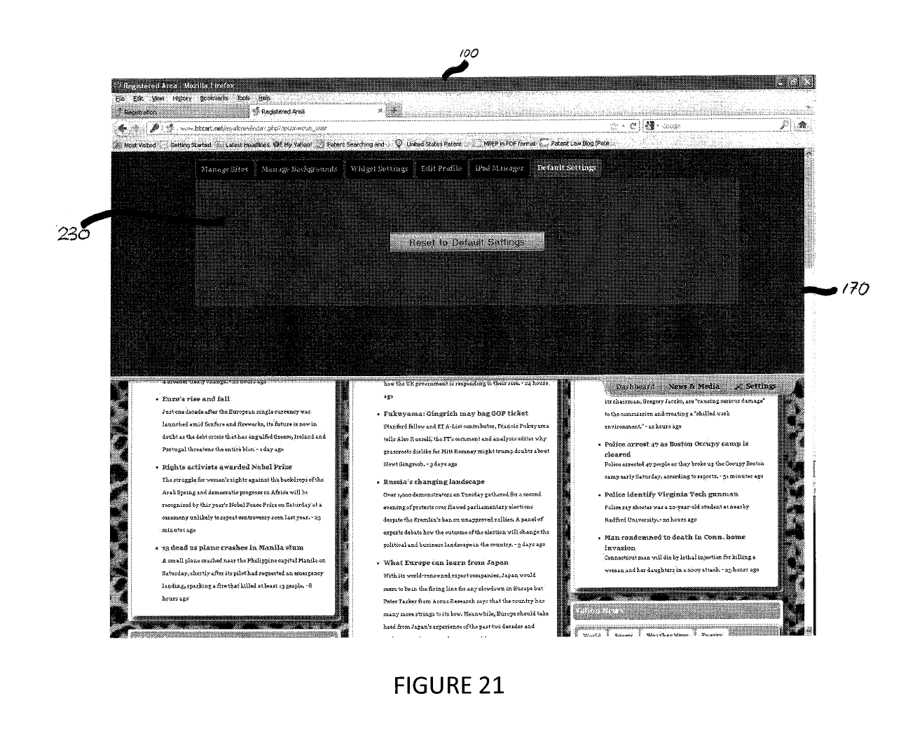

FIG. 21 shows a “default settings” device 230 of settings web page 170 displayed by web browser 100 after selection of the “default settings” tab. Upon selection of the “default settings” device 230, default settings for all functions of the settings web page 170 are reset to pre-defined values in the database of the host server. Furthermore, the dashboard web page and the settings web page immediately incorporate the default settings.

It is contemplated that the user device and host device are stand alone computers operating web browsers including desktop computers, laptop computers, netbook computers, tablet computers and handheld communication devices. Other embodiments are conceived for handheld communication and tablet devices which are capable of maintaining a secure communication session with the host server through a device specific application other than a web browser. Current platforms that support device specific applications, known commonly as “apps”, include the Google Android OS based smart phone and tablet devices and the Apple IOS based smart phone and table devices. An Android and IOS “app” is further contemplated to implement functions similar to those found in the dashboard web page, the news and media web page and the settings web page. Additionally, novel functions are conceived to aid the handheld device user in navigating and organizing personal information links

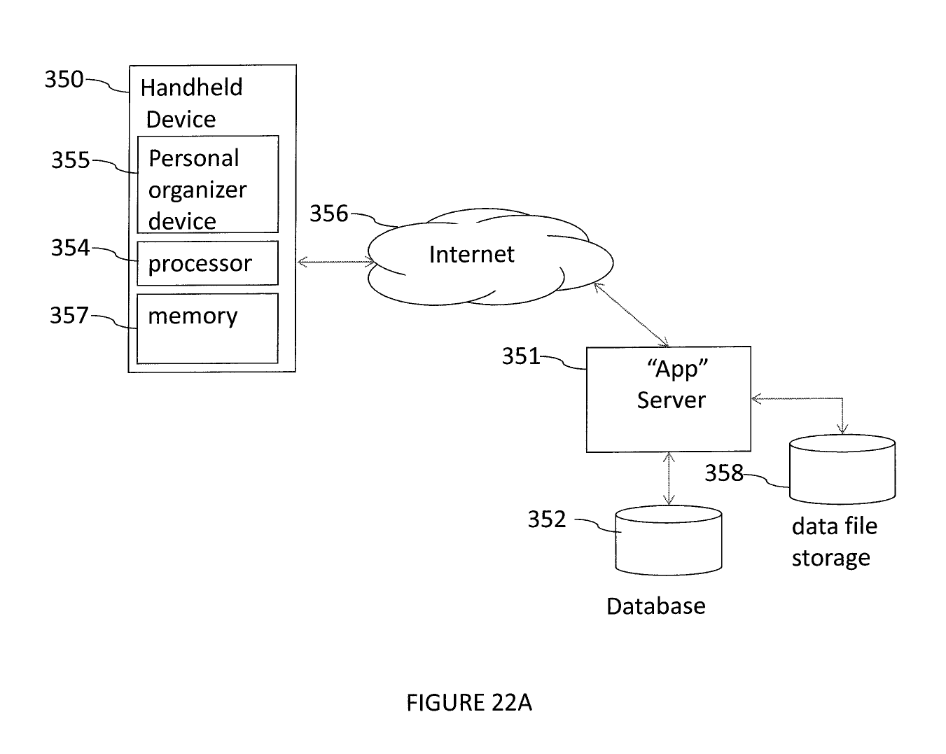

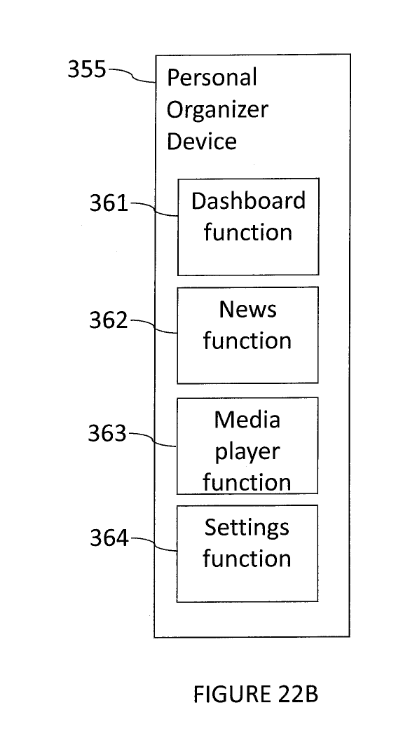

According to FIG. 22A, a handheld communication device 350 includes personal organizer device 355 as program instructions for a handheld “app” stored in memory 357 and executed by onboard processor 354. Personal organizer device 355 communicates with “app” server 351 through the internet 356 and exchanges data with database 352 and data file storage 358 through the “app” server 351. Database 352 is contemplated to be the same database that contains data associated to a username, further accessed by a host server as in FIG. 1 in communications with a dashboard web page, a settings web page and a news and media web page. By utilizing the same database, users will have similar experiences with a personal organizer device on the handheld device as with a personal organizer application using a web browser on a personal computer.

FIG. 22B is a block diagram of the personal organizer device 355 which comprises a dashboard function 361, a media player function 362, a news function 363 and a settings function 364.

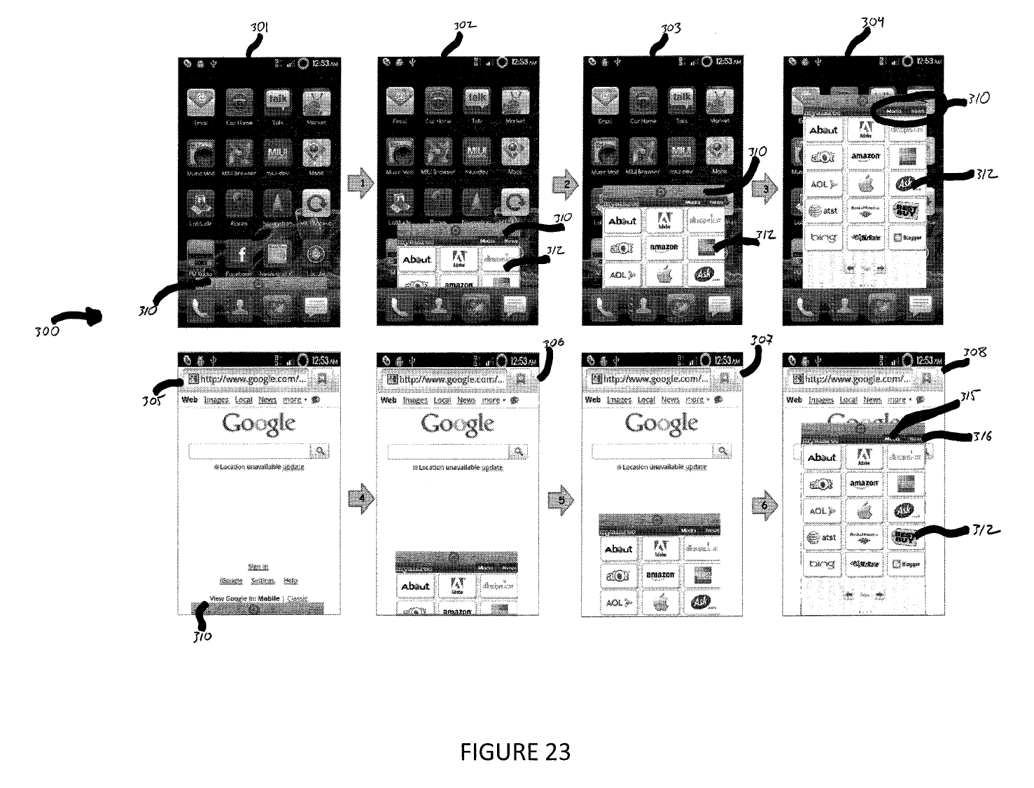

In use, the personal organizer device 355 is downloaded from a website or from an email attachment as the program instructions, loads the program instructions in memory 357, and starts the personal organizer device using standard functions available in the handheld communication device's operating system. Once started the personal organizer device executes dashboard function 361 and displays a dashboard slider bar as shown in FIG. 23 and explained further below.

FIG. 23 is a set of graphic screen images of a handheld communications device taken while operating personal organizer device 355 and showing the novel functions and features of personal organizer device 355. The handheld communications device includes a touch screen display for control and operation. The set of graphic screen images 300 progress in time from left to right for an application browser situation (top set) and for a web browser situation (bottom set). The handheld dashboard “app” is programmed to be available while the handheld device is in a local browsing mode shown in screen images 301-304. A first aspect of the dashboard function is a slider bar 310 normally situated near the bottom of the screen as in screen image 301. Slider bar 310 responds to touch screen movement as indicated in the progression from screen image 301 to screen images 302, 303 and then 304. As slider bar 310 is touched and moved upwards, a second dashboard function is revealed as in screen image 304. The second aspect of the dashboard function displays a selectable set of user weblinks 312 as a corresponding set of thumbnail images. The personal organizer device also includes media tab 315 and news tab 316.

In use, dashboard function communicates with the database to determine the selectable set of user weblinks 312. When a user selects a thumbnail image for a weblink, the dashboard function communicates to the database to receive username and login information required for the selected website associated to the selected thumbnail image. Then, the handheld communications device is instructed to open its native web browser application and display the selected website after authentication with the username and login.

When a website is opened, then the handheld communications device enters into web browsing mode, as in the bottom set of screen images including screen images 305-308. Slider bar 310 responds to touch screen movement as indicated in the progression from screen image 305 to screen images 306, 307 and then 308. As slider bar 310 is touched and moved upwards, the selectable set of user weblinks 312 and corresponding set of thumbnail images is displayed.

A novel aspect of the personal organizer device for handheld applications is the enablement of navigation from one web page to another which obviates the tedious use of a back function or forward function of the native web browser included in the handheld communications device. As a user migrates deeper into a selected web page accessed through a thumbnail image in slider bar 310, the current URL is saved in the database at the app server and is associated to the selected webpage. If the user closes the browser or migrates to a different website and then, at a later time, reopens the selected webpage from the slider bar, the connection manager object opens the saved current URL in the native web browser, if authentication is not required.

Further to the operation of the personal organizer device, when media tab 315 is selected a personal media player is displayed with media titles as listed in the database and stored in the data file storage accessible by the “app” server. The personal media player is enabled to play media files with all of the normal audio and video control functions. When news tab 316 is selected, a news and media screen is displayed with a selectable set of news feeds from a set of news sources.

The settings function in the personal organizer device is similar to the web browser based settings function of FIGS. 13-21, but formatted for the handheld communications device. The settings function is accessed through normal menu controls of the handheld communications device while the dashboard, media player or news and media screen is operating.

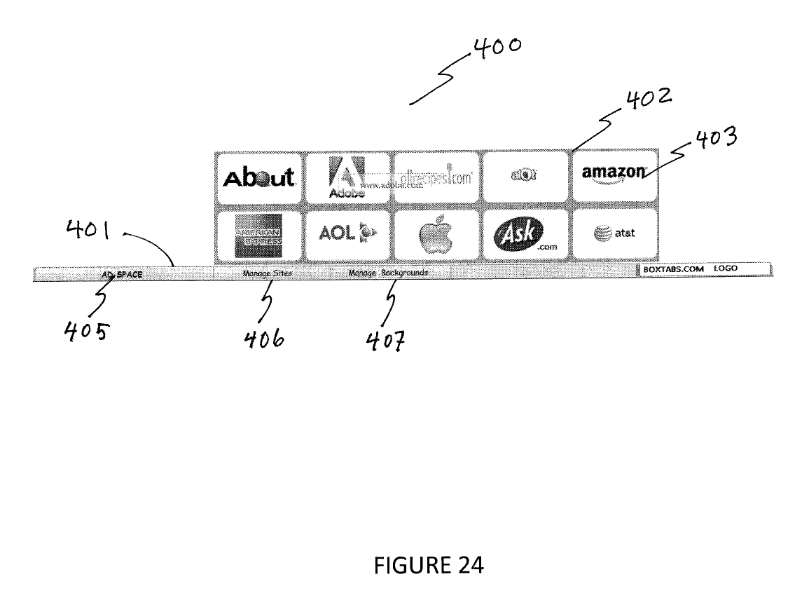

FIG. 24 shows a personal organizer tool 400 integrated into a web browser as an add-in device. Alternatively personal organizer tool 400 is integrated into a web page as a web tool. Personal organizer tool 400 is connected by the internet to a host server through a login process associated to a username and interoperates with a communication manager object and with a database similar to FIG. 1. Personal organizer tool 400 comprises a toolbar 401 with an ad selection area 405, a manage sites selector 406, a manage background selector 407 and a sliding area 402 which further comprises a set of selectable web links 403 with associated icon images.

In use, the sliding area 402 is normally in a down position near toolbar 401. When sliding area 402 is touched with a mouse click and pulled upward with a mouse click held down, the set of selectable web links 403 appear. When a selectable web link is clicked, an “iframe” similar to the “iframe” of the dashboard web page appears with a web page corresponding to the selectable web link. When ad selection area 405 is selected, an advertisement appears in an “iframe” and is made operable for additional interaction including purchase. When manage sites selector 406 is selected a website manager device similar to FIGS. 13 and 14 are implemented and displayed by personal organizer tool. When manage backgrounds selector 407 is selected, a background image manager similar to the device in FIG. 15 is implemented and displayed by the personal organizer tool. All information selected in the personal organizer tool is uploaded to the database and associated to the logged-in username.

It should be emphasized that the above-described systems and methods of the present invention, particularly, any exemplary embodiments, are merely possible examples of implementations and are merely set forth for providing a clear understanding of the principles of the invention. The descriptions in this specification are for purposes of illustration only and are not to be construed in a limiting sense. Many variations will be apparent to persons skilled in the art upon reference to the description and may be made to the above-described embodiments of the invention without departing substantially from the spirit and principles of the invention. All such modifications and variations are intended to be included herein within the scope of this disclosure and the present invention and protected by the following claims.

1. A personal organizer utilizing a client computer running a web browser and an advertiser server connected to the internet, comprising:
a host server connected to the internet, including a memory and a processor;
a database attached to the host server comprising a user profile, wherein the user profile includes a set of favorite web URLs, a list of media titles and a set of usernames and a passwords associated to the user;
a data file storage attached to the host server including a set of media files associated with the list of media titles;
a set of programmable instructions stored in the memory, when executed by the processor of the host server, carries out the steps of:
creating a communications manager object communicatively connected to the database;
creating a dashboard web page based on the user profile including a selectable set of weblinks to the set of favorite web URLs and a media player;
implementing the dashboard web page on the web browser with the communications manager object;
creating a settings web page based on the user profile;
implementing the settings web page on the web browser with the communications manager object;
collecting a user profile data from the settings web page and updating the user profile in the database based on the user profile data;
collecting the set of media files from the settings web page and storing the set of media files in the data file storage;
creating a news web page based on a pre-defined set of news feeds;
implementing the news web page on the web browser with the communications manager object;
displaying an “iframe” web browser tool in response to a selection of a weblink in the selectable set of weblinks; and,
playing a media file from the data file storage in response to a selection of a media title from the list of media titles with the communications manager object.

2. The personal organizer of claim 1 wherein the set of programmable instructions when executed by the processor, further carry out the steps of:
creating a special API;
communicating with a web service associated with the selected weblink;
exchanging a first username and a first password with web service, the special API authenticating the first username and the first password with the web service; and,
displaying a first webpage from the web service after authentication.

3. The personal organizer of claim 1 wherein the database further comprises an advertiser profile for an advertiser, an advertisement graphic and an advertisement schedule.

4. The personal organizer of claim 3 wherein the set of programmable instructions when executed by the processor, further carries out the steps of:
communicatively connecting the communications manager object to the advertiser server;
creating an advertisement based on the advertiser profile, the advertisement schedule and the advertisement graphic;
the communications manager object implementing the advertisement in the dashboard web page;
the communications manager object monitoring the advertisement for a selection event; and,
the communications manager object accounting for the selection event and billing the advertiser for the selection event.
